(19) United States
(12) Patent Application Publication
(10) Pub. No.: US 2019/0168649 A1
(43) Pub. Date: Jun. 6, 2019

(54) ADJUSTABLE HEAD RESTRAINT

(71) Applicant: ADIENT LUXEMBOURG HOLDING S.Á.R.L., Luxembourg (LU)

(72) Inventor: Peter Wayne WATSON, Victoria (AU)

(21) Appl. No.: 16/320,779

(22) PCT Filed: Jul. 12, 2017
(86) PCT No.: PCT/AU2017/050717

§ 371 Date: Jan. 25, 2019

Related U.S. Application Data
(60) Provisional application No. 62/367,102, filed on Jul. 26, 2016.

(30) Foreign Application Priority Data
Aug. 2, 2016 (AU) 2016903043

(51) Int. Cl. B60N 2/821; B60N 2/829; B60N 2/85; B60N 2/853; B60N 2/894

(52) U.S. Cl. CPC B60N 2/821; B60N 2/829; B60N 2/894; B60N 2/853; B60N 2/85

(57) ABSTRACT

An adjustable seat head restraint includes a first head restraint part including at least one connection component to connect the head restraint to a seat. A second head restraint part is provided. A coupling component couples the first and second head restraint parts together while allowing relative movement therebetween. At least one motor is provided to cause one or both of vertical relative movement and angular relative movement between the first and the second head restraint parts.

### CROSS REFERENCE TO RELATED APPLICATIONS

This application is a United States National Phase Application of International Application PCT/AU2017/050717 filed Jul. 12, 2017, and claims the benefit of priority under 35 U.S.C. § 119 of U.S. Provisional application 62/367,102, filed Jul. 26, 2016 and Australian Application 2016903043, filed Aug. 2, 2016, the entire contents of which are incorporated herein by reference.

### TECHNICAL FIELD

Embodiments generally relate to adjustable head restraints. In particular, embodiments relate to adjustable head restraints suitable for seats, such as automotive seats.

### BACKGROUND

Some head restraints, such as vehicle head restraints, do not permit much adjustment in position. It is desired to address or ameliorate one or more shortcomings or disadvantages associated with prior head restraints, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

Some embodiments relate to an adjustable seat head restraint, comprising: a first head restraint part comprising at least one connection component to connect the head restraint to a seat; a second head restraint part; a coupling component to couple the first and second head restraint parts together while allowing relative movement therebetween; and at least one motor to cause one or both of vertical and angular relative movement between the first and second head restraint parts.

The first motor may be disposed in the first head restraint part.

The second motor may be disposed in the second head restraint part.

The second head restraint part may comprise a front cushioning portion for occupant head support and cushioning.

The first head restraint portion may be vertically adjustable relative to the seat.

Power and/or control signals for operation of the at least one motor may be supplied via an electrical conductor extending through the seat and through the at least one connection component. The at least one motor may comprise a first motor to cause vertical relative movement between the first and second head restraint parts and a second motor to cause angular relative movement between the first and second head restraint parts.

The first head restraint part may comprise a mount to which the first motor is coupled, the mount connecting to the at least one connection component. Power and/or control signals may be supplied to the second motor via an electrical conductor passing through the coupling component. Power and/or control signals to the at least one motor can be selectively applied by a control unit nearby, such as within the seat or another part of a vehicle.

The at least one connection component may comprise two poles to be received in pole guides in the seat.

Some embodiments relate to a method of manufacturing a seat head restraint, comprising: forming a first head restraint part comprising at least one connection component to connect the head restraint to a seat; forming a second head restraint part; coupling the first and second head restraint parts together with a coupling component while allowing relative movement between the first and second head restraint parts; and providing at least one motor arranged to cause one or both of vertical and angular relative movement between the first and second head restraint parts.

The at least one motor may comprise a first motor to cause vertical relative movement between the first and second head restraint parts and a second motor to cause angular relative movement between the first and second head restraint parts. Providing at least one motor may comprise disposing the first motor in the first head restraint part. Providing at least one motor may comprise disposing the second motor in the second head restraint part.

Embodiments are described in further detail below by way of example, with reference to the accompanying drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1A is a front view of a head restraint according to some embodiments in an unextended configuration;

FIG. 1B is a side view of the head restraint of FIG. 1A;

FIG. 1C is a rear view of the head restraint of FIG. 1A;

FIG. 1D is a top view of the head restraint of FIG. 1A;

FIG. 2A is a front view of the head restraint of FIG. 1A in an extended configuration;

FIG. 2B is a side view of the head restraint of FIG. 2A;

FIG. 2C is a rear view of the head restraint of FIG. 2A;

FIG. 2D is a top view of the head restraint of FIG. 2A;

FIG. 2E is a perspective view of the head restraint of FIG. 2A;

FIG. 3 is an exploded perspective view of the head restraint according to some embodiments;

FIG. 4A is a close-up exploded perspective view of a support structure and first mechanism of the head restraint shown in FIG. 3;

FIG. 4B is a perspective view of the first mechanism of FIG. 4A in an assembled state;

FIG. 4C is a perspective view of the first mechanism of FIG. 4A mounted to the support structure of FIG. 4A;

FIG. 5A is an exploded perspective view of a second mechanism of the head restraint shown in FIG. 3;

FIG. 5B is a perspective cutaway view of the second mechanism of FIG. 5A in an assembled state;

FIG. 5C is a cross-section showing part of the second mechanism of FIG. 5A in further detail;

FIG. 6A is a cross-sectional view of the head restraint showing section A-A as indicated in FIG. 2D;

FIG. 6B is a cross-sectional view of the head restraint in an extended configuration showing section B-B as indicated in FIG. 2D;

FIG. 7A is a front perspective view showing the second mechanism of FIG. 5A mounted to the support structure of FIG. 4A;

FIG. 7B is a rear perspective view showing the first mechanism of FIG. 4A mounted to the support structure of FIG. 4A;

FIG. 8 is a perspective view of a support structure mounted to a seat frame according to some embodiments; and

FIG. 9 is a side view of the head restraint of FIG. 1A illustrating the difference between the extended and unextended configurations.

### DESCRIPTION OF PREFERRED EMBODIMENTS

Referring to the drawings, embodiments generally relate to adjustable head restraints. In particular, embodiments relate to adjustable head restraints suitable for seats, such as automotive seats. Such head restraints may also be described as headrests.

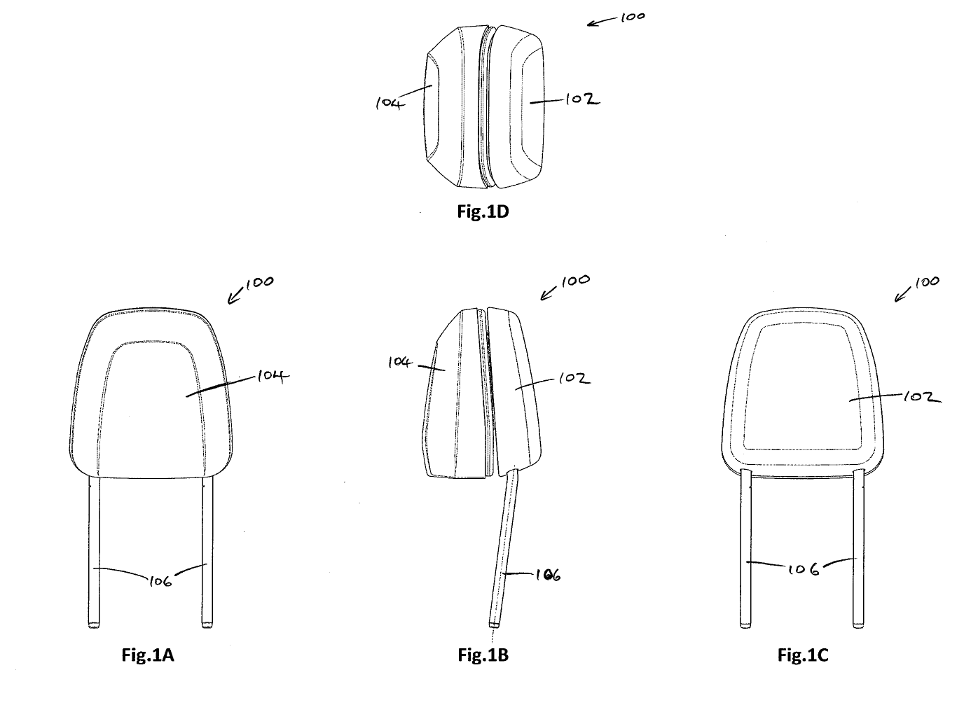

Referring to FIGS. 1A to 1D, a head restraint 100 is shown according to some embodiments. The head restraint 100 comprises a first head restraint part 102 and a second head restraint part 104. The first head restraint part 102 may be coupled to a seat (not shown) via at least one connection component to mount the head restraint 100 on the seat. The at least one connection component may comprise two support poles 106 as shown in the drawings. The first head restraint part 102 is roughly one half of the whole head restraint 100, while the second head restraint part 104 is roughly the other half of the head restraint 100, where the two halves are divided approximately by a vertical or mostly vertical plane. FIGS. 1A to 1D show the head restraint 100 with the second head restraint part 104 in an unextended or retracted position or configuration.

The second head restraint part 104 is movable relative to the first head restraint part 102 to allow adjustment of the head restraint 100. The second head restraint 104 may be vertically adjustable relative to the first head restraint part 102. The second head restraint 104 may be angularly adjustable by rotating or tilting the second head restraint part 104 relative to the first head restraint part 102.

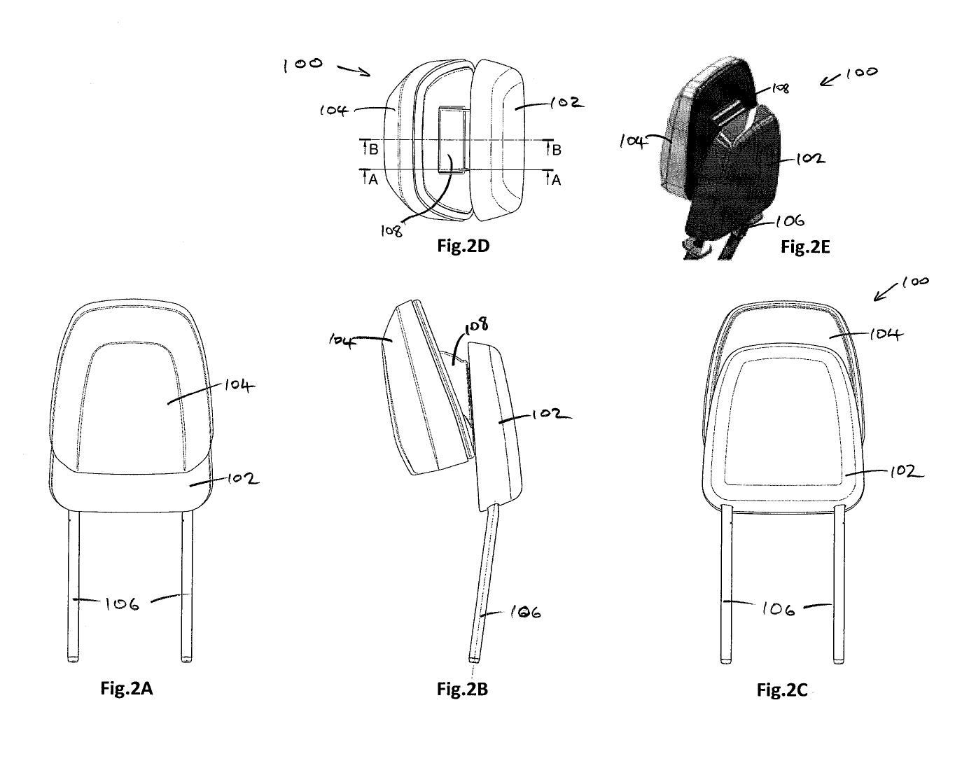

Referring to FIGS. 2A to 2E, the head restraint 100 is shown in a (fully) extended configuration in which the second head restraint part 104 has been adjusted vertically upwards and tilted away from the first head restraint part 102. In FIG. 2A, the second head restraint part 104 is also shown (by a dashed outline) in an unextended configuration as shown in FIGS. 1A to 1D. As is most easily seen in FIG. 2B, in the extended configuration, a top portion of the second head restraint part 104 is moved vertically and horizontally away (separated) from the first head restraint part 102 further than a bottom portion of the second head restraint part 104. In the extended configuration, the bottom portion of the second head restraint part 104 may remain close to or adjacent the first head restraint part 102. The second head restraint part 104 is movable to various positions between the fully extended position (FIGS. 2A to 2E) and the fully retracted position (FIGS. 1A to 1D).

The head restraint 100 comprises a coupling component 108 that connects the second head restraint part 104 to the first head restraint part 102 and allows relative movement between the first and second head restraint parts 102, 104 as described above.

The head restraint 100 may comprise one or more mechanisms to control and drive the relative movement between the first and second head restraint parts 102, 104, and may comprise one or more motors which can be operated to adjust the relative position and angle of the second head restraint part 104 relative to the first head restraint part 102.

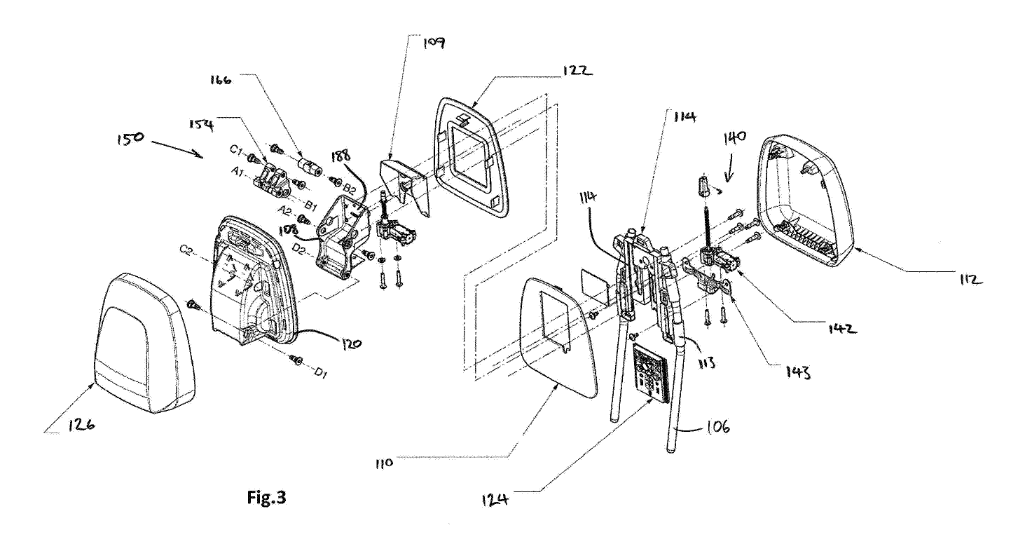

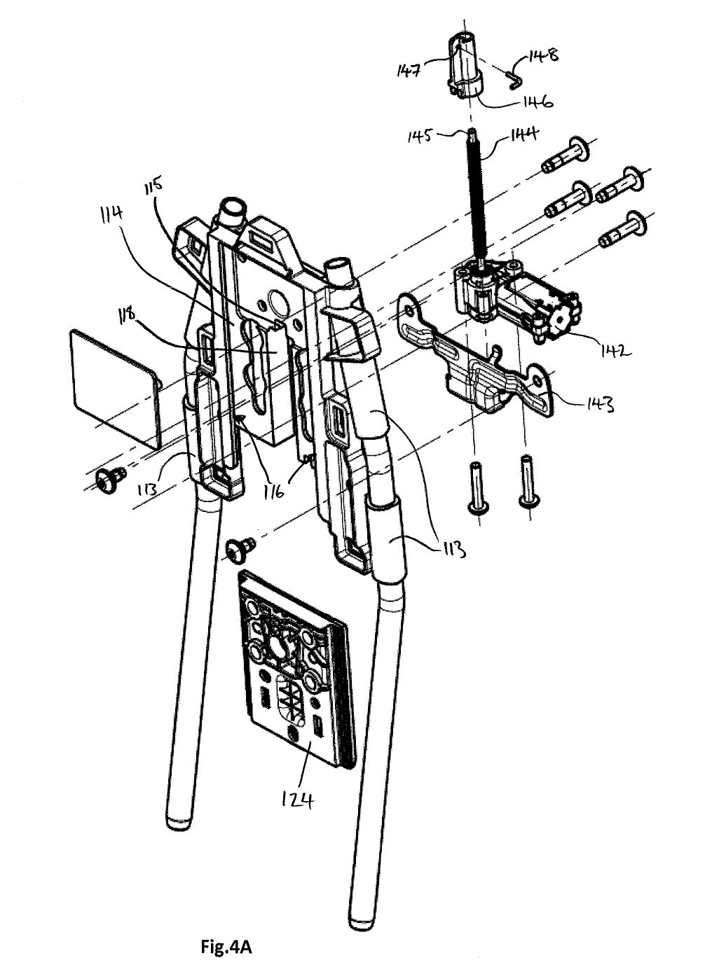

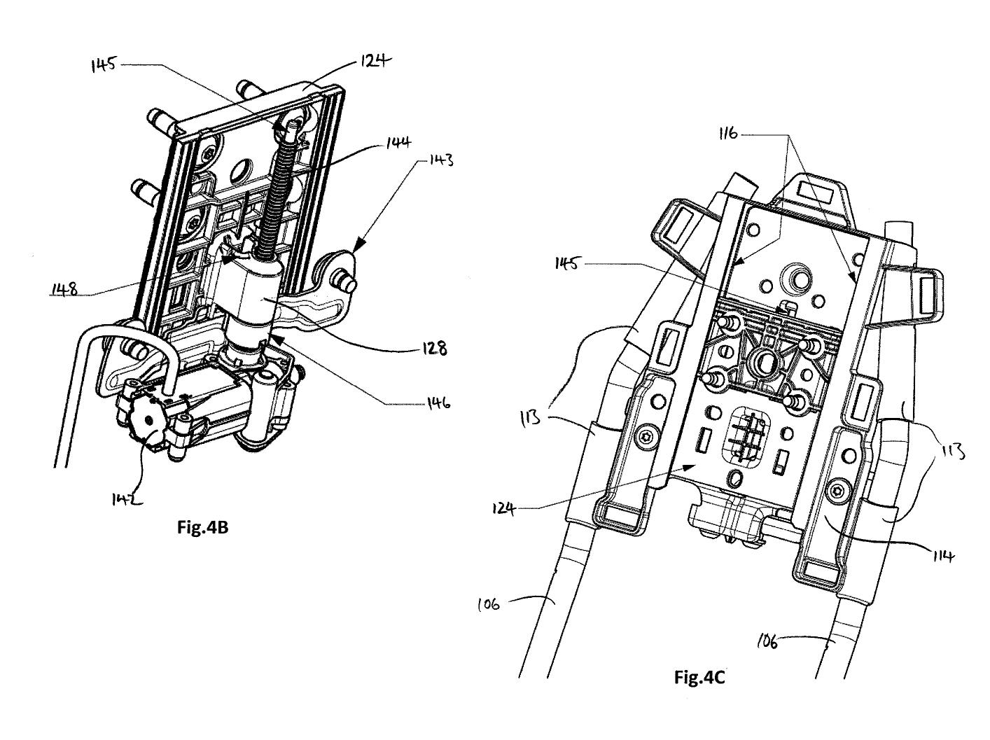

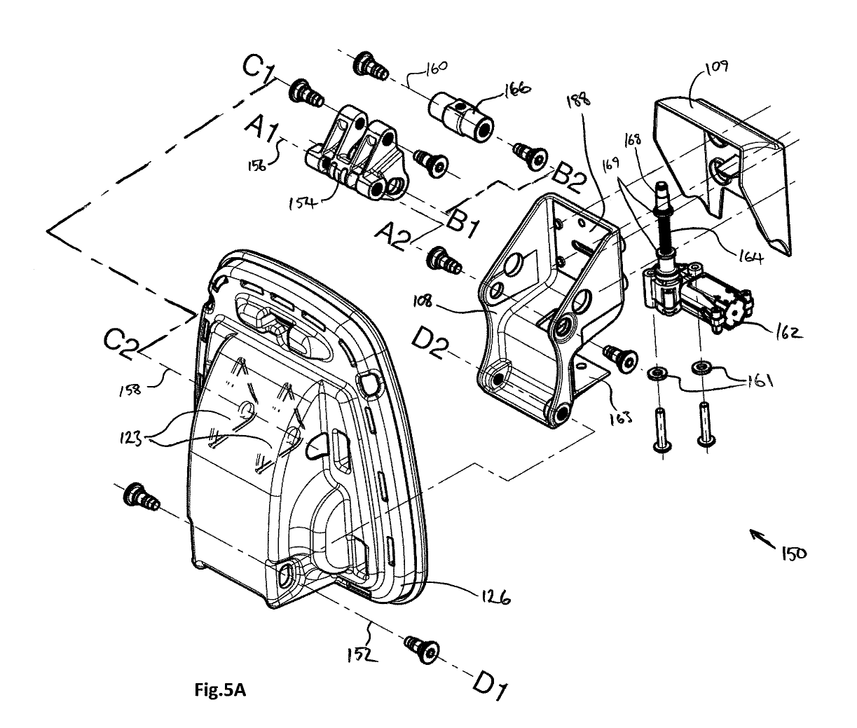

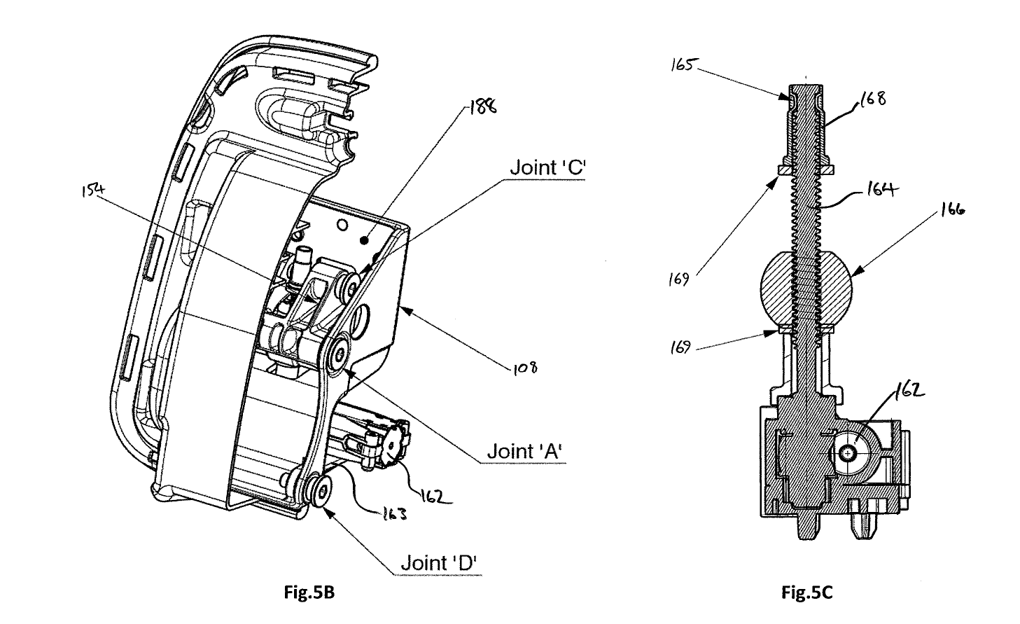

Referring to FIG. 3, an exploded view of the head restraint 100 is shown according to some embodiments. The head restraint comprises a first movement mechanism 140 configured to allow vertical relative movement between the first and second head restraint parts 102, 104, and a second movement mechanism 150 configured to allow angular relative movement between the first and second head restraint parts 102, 104. However, in some embodiments, the vertical and angular movement may be achieved with a single mechanism. The first and second mechanisms 140, 150 are described in further detail in relation to FIGS. 4A to 4C and 5A to 5C, respectively.

The first mechanism 140 is housed in the first head restraint part 102, which comprises a first front housing part 110 and a first rear housing part 112 which cooperate to house the first mechanism 140. The first head restraint part 102 also houses a mounting structure 114 which mounts the first head restraint part 102 on the supports 106. As discussed above, each support pole 106 may provide one example of a connection component. In some embodiments, the at least one connection component may comprise internal receiving structures 113 which may form part of the mounting structure 114.

The second mechanism 140 is housed in the second head restraint part 104, which comprises a second front housing part 120 and a second rear housing part 122, which cooperate to house the second mechanism 150. The second head restraint part 104 also houses the coupling component 108 (in the unextended configuration), which is coupled to the mounting structure 114 via a slidable carrier or slider 124. The second head restraint part 104 further comprises a pad or front cushioning portion 126, which is configured to fit over the second front housing part 120 for occupant head support and cushioning.

Referring to FIG. 4A, the first movement mechanism 140 is shown in more detail. The slider 124 is configured to be coupled to and slide in tracks 116 in the mounting structure 114. The first mechanism 140 comprises a first motor 142 mounted (and fixed in position relative) to the mounting structure 114 by a first mounting bracket 143 and configured to drive rotation of a first threaded spindle 144. A first threaded drive nut 146 is configured to be coupled to the slider 124 and to move along the spindle 144 by threaded engagement when the spindle 144 is rotated by the first motor 142, thereby moving the slider 124 vertically up or down relative to the first head restraint part 102.

The drive nut 146 includes an aperture 147 configured to receive a locking pin 148. Referring to FIG. 4B, the slider 124 comprises a drive nut seat 128 configured to receive at least part of the first drive nut 146 in an internal cavity (not shown) of the drive nut seat 128. The drive nut seat 128 also includes an aperture (not shown) configured to receive the locking pin 148. Once the drive nut 146 is received in the drive nut seat 128, the locking pin 148 may be inserted through the apertures 127, 147 to couple the drive nut 146 to the slider 124. The drive nut seat 128 also defines a top aperture through which the spindle 144 passes as the drive nut seat 128 and drive nut 146 are moved up or down by rotation of the spindle 144. In some embodiments, the drive nut 146 may be coupled to the slider 124 by a suitable releasable mechanical coupling other than the drive nut seat 128 and locking pin 148.

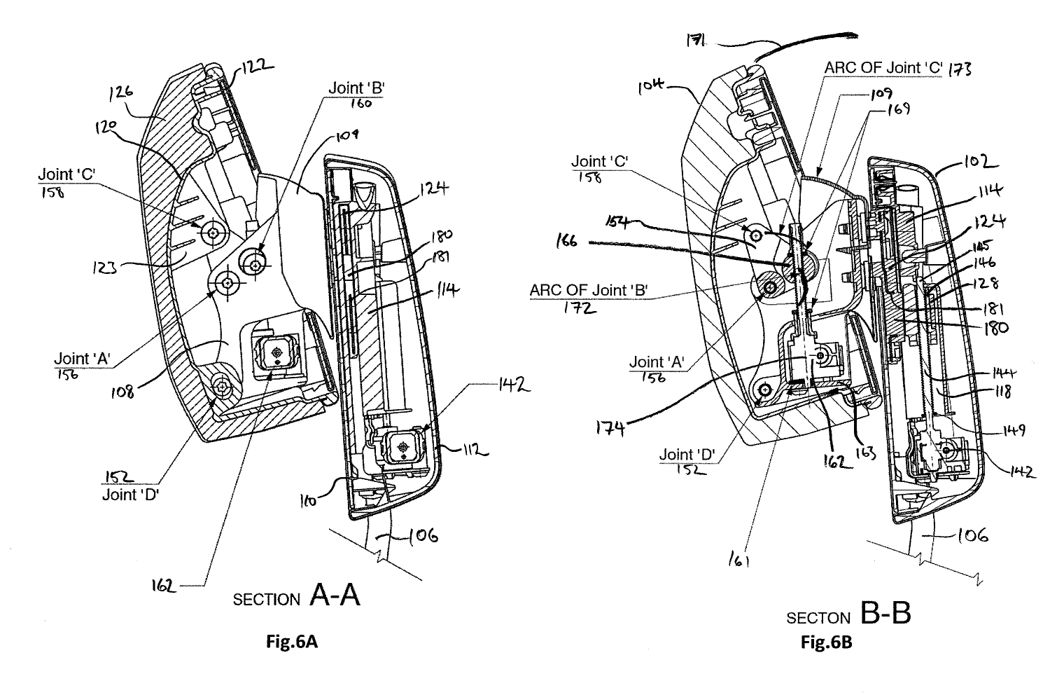

Referring to FIGS. 4A and 6B, the mounting structure 114 defines a channel 118 configured to receive and surround part of the drive nut seat 128 and allow it to move along the channel 118 as the slider 124 moves relative to the mounting structure 114.

In some embodiments, the first mechanism 140 may comprise a stop 149 such as a plastic washer, for example, disposed around the first spindle 144, for example at a base thereof, near the first motor 142. The stop 149 may restrict the first drive nut 146 from being drawn hard against the first motor 142 and causing thread bind.

A distal end 145 of the first spindle 144 (distal to the first motor 142) may be received in a recess or slot 115 formed in the mounting structure 114 at an end of the channel 118 as shown in FIGS. 4A to 4C and 6B. Walls of the channel 118 adjacent the slot 115 may also act as a stop to limit the movement of the drive nut seat 128 and first drive nut 146 along the first spindle 144.

Referring to FIGS. 5A to 5C, the second mechanism 150 is shown in more detail. The coupling component 108 is coupled to the slider 124, for example by suitable coupling mechanisms, such as fasteners, so that the second head restraint part 104 moves vertically with the slider 124. The second front housing part 120 is pivotally coupled to the coupling component 108 at a first axis 152 shown as D1-D2 in FIG. 5A and forming Joint ‘D’ elsewhere in the drawings. First axis 152 is positioned at a lower front portion of the second front housing part 120. A lever 154 is pivotally coupled to the coupling component 108 at a second axis 156 shown as A1-A2 in FIG. 5A and forming Joint ‘A’ elsewhere in the drawings. The second axis 156 is generally defined by the coupling component 108 to be generally vertically above the first axis 152. The lever 154 is also pivotally connected to the second front housing part 120 at a third axis 158 shown as C1-C2 in FIG. 5A and forming Joint ‘C’ elsewhere in the drawings. The third axis 158 is horizontally offset in a rearward direction from the first and second axes 152, 156. The third axis 158 rotates around the second axis 156 in response to operation of the second motor 162. The front housing part 120 may comprise one or more brackets 123 defining apertures to couple the front housing part 120 to the lever 154 to form Joint ‘C’.

The second mechanism 150 comprises a second motor 162 mounted to the coupling component 108 by a second mounting bracket 163 and configured to drive a second threaded spindle 164. A second drive nut 166 is configured to threadedly move along the second spindle 164 when it is rotated by the second motor 162 by engagement of complementary screw threads on the second spindle 164 and the second drive nut 166. The second drive nut 166 is pivotally coupled to the lever 154 at a fourth axis 160 coinciding with apertures defined by the lever 154, such that when the second motor 162 is actuated, the second drive nut 166 is moved along the second spindle 164 to rotate the lever 154 relative to the coupling component 108 and thereby tilt the second head restraint part 104 relative to the coupling component 108 and the first head restraint part 104. Lever 154 defines a second drive nut seat (not shown) therein to receive the second drive nut 166. The lever 154 allows rotation of the second drive nut 166 within the second drive nut seat as the drive nut 166 progress along the spindle 164. The fourth axis 160 is shown as B1-B2 in FIG. 5A and forming Joint ‘B’ elsewhere in the drawings. The fourth axis 160 is generally vertically below the third axis 158, is horizontally offset from the first and second axes 152, 156 and rotates relative to the first and second axes 152, 156 in response to actuation of the second motor 162. The first, second, third and fourth axes 152, 156, 158 and 160 are all substantially parallel with each other.

The second mechanism 150 may comprise an end cap or stop tube 168 to limit movement of the second drive nut 166 along the second spindle 164. A slot or groove 165 may be defined in the second spindle 164 at or near a distal end of the spindle 164. The stop tube 168 may be crimped onto the spindle 164 and into the groove 165. In some embodiments, the end cap or stop tube 168 may comprise a clip or barbs configured to engage the groove 165 and restrict removal of the stop tube 168 from the second spindle 164. The second mechanism 150 may further comprise plastic washers 169 disposed around the second spindle 164 on either side of the second drive nut 166 to restrict the second drive nut 166 from being drawn hard against the second motor 162 or stop tube 168 and causing thread bind.

The head restraint 100 may further comprise a cover 109 to hide the coupling component 108 and internal mechanisms of the head restraint 100. The cover 109 may be fixed relative to the first head restraint part 102 and may define a curved surface configured such that, as the second mechanism 150 is actuated to rotate the second head restraint part 104 relative to the first head restraint part 102 to adjust the angular position of the second head restraint part 104, a constant clearance is maintained between the cover 109 and the second head restraint part 104. The clearance may be in the range of about 0.1 mm to 5 mm, optionally about 0.5 mm to 3 mm, optionally about 1 mm to 2 mm.

Referring to FIG. 6B, a cross-section of the first and second mechanisms 140, 150 is shown, illustrating the angular displacement or motion caused by the second mechanism 150 in the fully extended position. A first arc 171 is shown, illustrating the range of angular motion or rotation of a top part of the second head restraint part 104 relative to the first head restraint part 102 about axis 152 (Joint ‘D’). A second arc 172 illustrates the path (or motion range) of Joint ‘B’ 160 as the lever 154 rotates about axis 156 (Joint ‘A’) to the fully extended position. A third arc 173 illustrates the path (or motion range) of Joint ‘C’ 158 as the lever 154 rotates about axis 156 (Joint ‘A’) to the fully extended position.

As the second drive nut 166 moves up and down over time along the second spindle 164 (by actuation of the second motor 162) and drives the motion of the lever 154, the movement of Joint ‘B’ 160 (and thus the second drive nut 166) through the second arc 172 will cause the second spindle 164 to oscillate. That is, as the second motor is operated at various times in a backward or forward driving direction, a longitudinal axis 174 of the second spindle 164 will be rotated such that the distal end of the second spindle 164 is caused to move back and forth, towards and away from the first head restraint part 102. This motion may also rock the second motor 162 back and forth in a similar manner. In order to allow for this oscillation and mitigate against such oscillation causing bending stress between the second motor 162 and the second spindle 164, the second motor 162 may be mounted to the second mounting bracket 163 with flexible or deformable washers 161 disposed between the second motor 162 and the second mounting bracket 163. Alternatively, the second motor 162 may be mounted to the second mounting bracket 163 in a way that allows for some angular deflection or rotation of the second motor 162 relative to the mounting bracket 163 as the spindle 164 is angularly deflected by the action of the drive nut 166 and the lever 154.

Coupling component 108 acts as a mounting bracket for the second motor 162 and for pivot couplings, such as screws, to allow pivotal movement of the lever 154 relative to the coupling component 108 and allow pivotal movement of the coupling component relative to the second front housing part 120. The coupling component 108 has a slotted aperture formed in a central web thereof, with the spindle 164 extending through the slotted aperture. The slotted aperture allows for some back and forth movement of the spindle 164 as it interacts with the drive nut 166 and the lever 154, as described above. The structure of the coupling component 108 resembles a chair (as seen from the perspective shown in FIG. 5A), with an upper back part comprising a stiffening plate 188 and side plate portions extending from the stiffening plate 188 in a forward direction resembling chair arms. The central web that defines the slotted aperture is integrally formed with the side plate portions and the stiffening plate 188 and resembles a seat of the chair-like structure of the coupling component. A front mounting section of the coupling component 108 (spaced from the back stiffening plate 188) defines opposed apertures defining the first and second axes 152, 156 and that receive pivot couplings, such as screws, that allow pivoting about the axes 152, 156. The second mounting bracket 163 extends rearwardly from a front of the coupling component 108 and resembles a foot of the chair-like structure of the coupling component 108.

In general, the components described herein may be formed of any suitable materials with sufficient stiffness to support the expected design loads. For example, in order to meet safety standards for a head restraint for an automotive seat, the head restraint 100 must provide a certain level of support and resistance to impact loads which are predicted in certain car collisions. Some suitable materials for the components described are metals, metal alloys, steel, aluminum, or rigid plastics, such as acetal, for example.

In some embodiments, the slider 124 may be formed of a rigid plastic 180 molded around a metal reinforcing structure such as a metal plate 181 as shown in FIGS. 6A and 6B.

In some embodiments, the coupling component 108 may be formed or molded in steel or other metal or molded in rigid plastic around a steel (or other metal) stiffening plate 188. The stiffening plate 188 may provide reinforcement and strengthen the connection between the slider 124 and the coupling component 108.

In some embodiments, the head restraint mounting structure 114 may be formed of a rigid plastic molded over the support poles 106. In some embodiments, the support poles 106 may comprise hollow steel tubes. The tubes may have a 150 mm pitch, for example.

In some embodiments, power and/or control signals for operation of the first and second motors 142, 162 may be supplied via the seat and through the at least one connection component. For example, electrical wiring may be passed through the hollow support poles 106 to connect the first and second motors 142, 162 to a power supply (not shown). In some embodiments, power and/or control signals may be supplied to the second motor 162 via an electrical conductor passing through the coupling component 108, slider 124 and/or mounting structure 114.

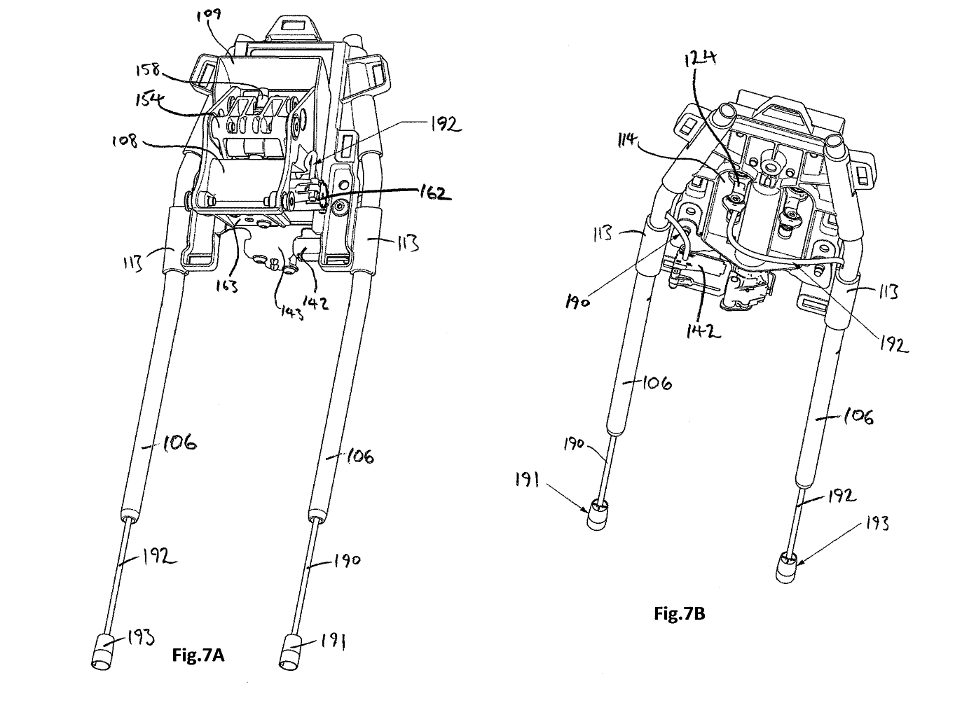

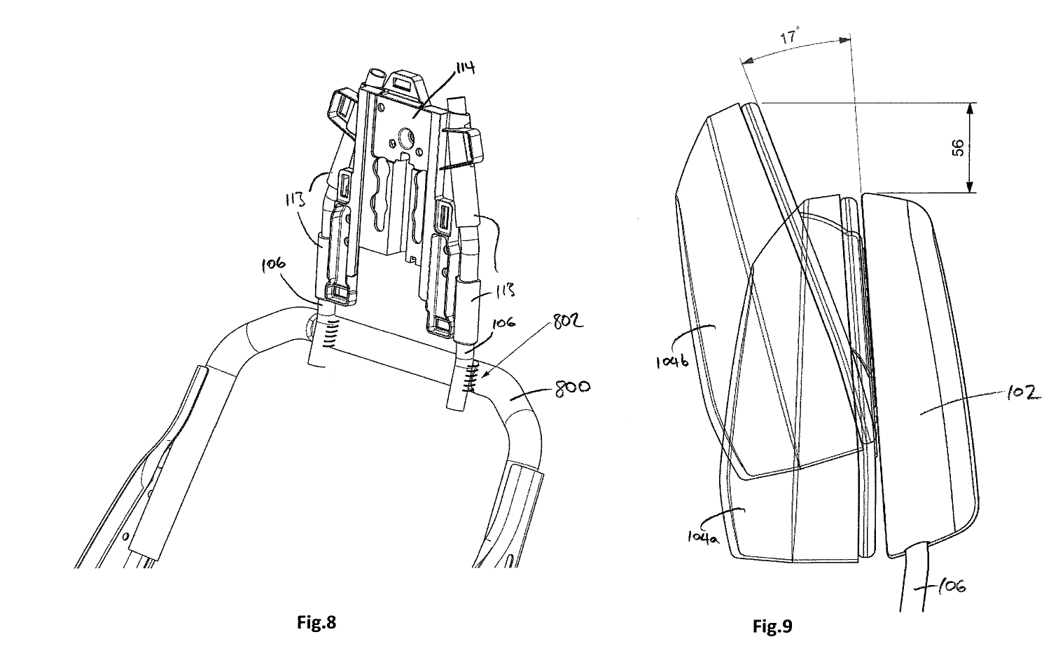

Referring to FIGS. 7A and 7B, a first power/signal cable 190 may extend through one of the support poles 106 to supply power to the first motor 142 and a second power/signal cable 192 may extend through another one of the support poles 106 to supply power to the second motor 162. The second cable 192 may also pass through apertures in the mounting structure 114, slider 124 and coupling component 108 to connect the second motor 162 to the power supply.

The first cable 190 may terminate in a first connector 191 configured to connect the first cable 190 to wiring within the main body of a car seat, for example. The second cable 192 may terminate in a second connector 193 configured to connect the second cable 192 to wiring within the main body of the car seat, for example. The first and second motors 142, 162 may be controlled by actuation of one or more manually operable switches (not shown) electrically coupled to a controller (not shown), which controls the supply of power to each motor 142, 162. In some embodiments, a controller may not necessarily be required and the switches may be directly coupled to the power supply and the motors 142, 162 to control the supply of power to the motors 142, 162. For example, the switches may comprise reverse polarity switches, one switch associated with each of the motors 142, 162. The switches may be mounted in the car seat or in a dashboard of the car, and may allow a user to operate each motor 142, 162 in both directions to move the second head restraint part 104 up and down and tilt the second head restraint part 104 towards and away from the first head restraint part 102. This allows adjustment of the head restraint in four directions (up, down, back and forward).

In some embodiments, the support poles 106 may be received and/or mounted in pole guides (not shown) to connect the support poles 106 to a car seat frame in a manually height-adjustable manner. In some embodiments, as shown in FIG. 8, the support poles 106 may be connected directly to the car seat frame 800 in a non-adjustable manner. Connections 802 between the support poles 106 and the car seat frame 800 may comprise welded joints, for example.

Referring to FIG. 9, the head restraint 100 is shown illustrating the difference between the extended and unextended configurations. As described above, the first and second mechanisms 140, 150 allow vertical and angular adjustment of the second head restraint part 104 relative to the first head restraint part 102. The second head restraint part 104 is indicated as 104a in an unextended position adjacent the first head restraint part 104 (i.e., with the head restraint 100 in the unextended configuration). The second head restraint part 104 is indicated as 104b in an extended position fully extended away from the first head restraint part 102 (i.e., with the head restraint 100 in the extended configuration). However, the first and second mechanisms 140, 150 allow adjustment of the vertical and angular position of the second head restraint 104 over a continuous range of distances and angles that are intermediate the unextended and fully extended positions. That is, the second head restraint part 104 may be adjustable to a plurality of intermediate positions between the extended and unextended positions. For each angular position, the vertical position may be adjusted continuously over the full vertical range, and for each vertical position, the angular position may be adjusted continuously over the full angular range.

The first mechanism 140 may be configured to allow adjustment of the vertical position of the second head restraint part 104 by a distance of up to about 200 mm, optionally up to about 100 mm, optionally up to about 56 mm, optionally up to about 30 mm.

The second mechanism 150 may be configured to allow adjustment of the angular position of the second head restraint part 104 away from the first head restraint part 102 by an angle of up to about 30°, optionally up to about 20°, optionally up to about 17°, optionally up to about 15°, optionally up to about 10°, optionally up to about 5°.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

While specific embodiments of the invention have been shown and described in detail to illustrate the application of the principles of the invention, it will be understood that the invention may be embodied otherwise without departing from such principles.

1. An adjustable seat head restraint, comprising:
a first head restraint part comprising at least one connection component to connect the head restraint to a seat;
a second head restraint part;
a coupling component to couple the first and second head restraint parts together while allowing relative movement therebetween; and
at least one motor to cause one or both of vertical and angular relative movement between the first and second head restraint parts.

2. The head restraint of claim 1, wherein the at least one motor comprises a first motor to cause vertical relative movement between the first and second head restraint parts and a second motor to cause angular relative movement between the first and second head restraint parts.

3. The head restraint of claim 2, wherein the first motor is disposed in the first head restraint part.

4. The head restraint of claim 2, wherein the second motor is disposed in the second head restraint part.

5. The head restraint of claim 1, wherein the second head restraint part comprises a front cushioning portion for occupant head support and cushioning.

6. The head restraint of claim 1, wherein the first head restraint portion is vertically adjustable relative to the seat.

7. The head restraint of claim 1, wherein power and/or control signals for operation of the at least one motor is supplied via the seat and through the at least one connection component.

8. The head restraint of claim 1, wherein the at least one connection component comprises two poles to be received in pole guides in the seat.

9. The head restraint of claim 2, wherein the first head restraint part comprises a mount to which the first motor is coupled, the mount connecting to the at least one connection component.

10. The head restraint of claim 2, further comprising an electrical conductor passing through the coupling component, wherein power and/or control signals is/are supplied to the second motor via the electrical conductor passing through the coupling component.

11. A method of manufacturing a seat head restraint, comprising:
forming a first head restraint part comprising at least one connection component to connect the head restraint to a seat;
forming a second head restraint part;
coupling the first and second head restraint parts together with a coupling component while allowing relative movement between the first and second head restraint parts; and
providing at least one motor arranged to cause one or both of vertical and angular relative movement between the first and second head restraint parts.

12. The method of claim 11, wherein the at least one motor comprises a first motor to cause vertical relative movement between the first and second head restraint parts and a second motor to cause angular relative movement between the first and second head restraint parts.

13. The method of claim 12, wherein providing at least one motor comprises disposing the first motor in the first head restraint part.

14. The method of claim 12, wherein providing at least one motor comprises disposing the second motor in the second head restraint part.

15. The method of claim 12, wherein the second head restraint part is formed with a front cushioning portion for occupant head support and cushioning.

16. The method of claim 12, wherein the first head restraint portion is vertically adjustable relative to the seat.

17. The method of 12, wherein power and/or control signals for operation of the at least one motor is supplied via the seat and through the at least one connection component.

18. The method of 17, wherein the at least one connection component comprises two poles to be received in pole guides in the seat.

19. The method of claim 12, wherein the first head restraint part comprises a mount to which the first motor is coupled, the mount connecting to the at least one connection component.

20. The method of claim 12, wherein the seat head restraint further comprises an electrical conductor passing through the coupling component, and further comprising supplying power and/or control signals to the second motor via the electrical conductor passing through the coupling component.
